(19) United States
(12) Patent Application Publication
(10) Pub. No.: US 2021/0286793 A1
(43) Pub. Date: Sep. 16, 2021

(54) INDEXING STORED DATA OBJECTS USING PROBABILISTIC FILTERS

(71) Applicant: EMC IP Holding Company LLC, Hopkinton, MA (US)

(72) Inventors: Derek OKeeffe, Cork (IE); Paul Barriscale, Cork (IE)

(73) Assignee: EMC IP Holding Company LLC, Hopkinton, MA (US)

(21) Appl. No.: 16/819,493

(22) Filed: Mar. 16, 2020

(51) Int. Cl. G06F 16/22; G06F 16/2455; G06F 16/182; G06F 16/335

(52) U.S. Cl. CPC G06F 16/2246; G06F 16/335; G06F 16/1824; G06F 16/24558

(57) ABSTRACT

A system and method index data objects in an object store according to structure found in data records from which the objects are themselves formed. Embodiments order structured data records, aggregate slices of consecutively-ordered records into a single corresponding data object, store the data object in the object store, and place the associated object handle into a search tree with all the other such handles. The search tree is indexed using probabilistic set-inclusion filters, such as Bloom filters, not on the handles themselves but on the indexed fields of the records within each slice. For data sets having enough data records, and thus search trees that are deep enough, the aggregate false positive rate for depth-first searches on the tree becomes infinitesimal due to the multiplicate property of the false positive rates for independent Bloom filters. Searches are rapid on even moderately tuned filters.

### FIELD

The disclosure pertains generally to database structures for information retrieval in electric digital data processing, and more particularly to the use of probabilistic filters on indices to determine a data storage location.

### BACKGROUND

Software applications generally have structured and unstructured data. Structured data comprise records having clearly defined datatypes that make them easily searchable and useful for computation, and such records are often stored in a database (especially a relational database management system, or RDBMS) that is optimized for rapid storage and retrieval. By contrast, unstructured data comprise “everything else” that is not as easily searched, such as image, audio, and video files, and often require much more storage space per item of data. Unstructured data may be used more for computation than for display, and in this regard are relatively static and unchanging, thus idea for relatively slow, bulk storage as opaque “data objects.”

Despite the relative conceptual cleanliness of this distinction, some applications must nevertheless access large sets of static (or very slowly changing) but structured data. These data may include for example transaction logs, such as may be generated by websites having complex interfaces, or web services having very high traffic. In these situations, an RDBMS is commonly the first choice, but databases are expensive for very large datasets (e.g. when a petabyte or more of such data are stored). An object store, such as the Dell-EMC Elastic Cloud Storage (ECS) or the Simple Storage Service (S3) from Amazon Web Services (AWS), is a lower-cost option to store large amounts of data, but indexing and retrieving these data is slow because cloud storage objects are more cumbersome to search than structured records in an RDBMS.

### SUMMARY OF DISCLOSED EMBODIMENTS

Disclosed embodiments combine the speed advantages of indexed data with the cost advantages of bulk-storage of large data objects by providing an indexing scheme for data objects that relies upon their underlying structure. Embodiments store many structured data records in a “slice” or collection, and slices are treated as opaque data objects for the purpose of storage and retrieval in a data object store that is optimized for storing unstructured data. To form the slices, records are sorted according to search keys created from a particular data access pattern. In other words, a set is chosen of database keys or other metadata that uniquely identify a particular structured data record, and these keys are concatenated or otherwise composed to form search keys that may be sorted. The database keys may come naturally from a template Structured Query Language (SQL) query as the fields used in its WHERE clause. The search keys are placed into a search tree having one leaf node for each data object and each node having a probabilistic filter, such as a Bloom filter, that indicates whether a given structured data record either probably is, or definitely is not, accessible from a subtree containing that node. Thus, the search tree operates on metadata that uniquely identify a particular structured data record, to locate and retrieve a data object containing the data record.

Unlike existing systems, indexed data objects advantageously may be stored and retrieved without requiring the object store to have any awareness of the underlying indexing system. Thus, data objects advantageously may be stored and retrieved using industry-standard cloud storage protocols, and in object stores provided by a wide variety of storage vendors. Data access may be performed regardless of the underlying data structure, which needs to be known only by the requesting database application. In particular, using embodiments with large (e.g. petabyte) structured data sets may reduce access costs, as opaque data object storage in the cloud often is less expensive per byte than RDBMS structured data record storage. And embodiments advantageously may permit a cloud-native app to break its dependence on a legacy RDBMS.

Thus, a first embodiment is a system for obtaining a structured data record. The system has a storage device for storing a search tree that covers the space of possible search keys. The search tree has nodes that each provide an approximate membership query filter for a subset of the possible search keys. The system also has a search key compositor for forming a search key as a composition of one or more values that index the structured data record, whereby the search key is uniquely associated with the structured data record. The system further has a search processor for searching the search tree, starting from a root node and continuing until a leaf node is reached. For each encountered node, the filter for that node is used to determine whether a subtree containing that node cannot include the search key, and if that is not the case, then that subtree is traversed. The system also includes a communication device for communicating, to a data object store, a pointer associated with the leaf node that was reached, and for responsively receiving, from the data object store, a data object having a plurality of data records, of which the structured data record is one.

In some embodiments, the storage device stores a binary search tree.

In some embodiments, each node in the search tree stored in the storage device provides an approximate membership query filter comprising a Bloom filter, or a quotient filter, or a cuckoo filter, according to a characteristic false positive probability between 1% and 30%.

In some embodiments, the search key compositor is configured to form the search key as a composition of one or more database keys that index the structured data record.

In some embodiments, the search key compositor is configured to form the search key to include a sequence number of the data record within the plurality of data records in the data object to be received.

In some embodiments, the communication device is configured for communicating with a data object store that comprises a cloud storage service or a cloud storage device.

Another embodiment is a method of obtaining a structured data record. The method includes forming a search key as a composition of one or more values that index the structured data record, whereby the search key is uniquely associated with the structured data record. The method next includes traversing a search tree that covers the space of possible search keys, starting from a root node and continuing until a leaf node is reached, by: for each encountered node, using an approximate membership query filter for that node to determine whether a subtree containing that node cannot include the search key, and if that is not the case, then traversing that subtree. The method then requires communicating, to a data object store, a pointer associated with the leaf node that was reached; and responsively receiving, from the data object store, a data object having a plurality of data records, of which the structured data record is one.

In some embodiments, the search tree includes a binary search tree.

In some embodiments, using the approximate membership query filter for each encountered node comprises using a Bloom filter, or a quotient filter, or a cuckoo filter, according to a characteristic false positive probability. The characteristic false positive probability may be between 1% and 30%.

In some embodiments, forming the search key comprises forming the search key as a composition of one or more database keys that index the structured data record.

In some embodiments, forming the search key comprises forming the search key including a sequence number of the data record within the plurality of data records in the data object to be received.

In some embodiments, the data object store is a cloud storage service or cloud storage device.

Yet another embodiment is a tangible, computer-readable storage medium, in which is non-transitorily stored computer program code for performing the above method or any of its variants.

It is appreciated that the concepts, techniques, and structures disclosed herein may be advantageously embodied in other ways, so the embodiments listed above should not be viewed as limiting the scope of the inventive subject matter.

### DESCRIPTION OF THE SEVERAL VIEWS OF THE DRAWINGS

The manner and process of making and using the disclosed embodiments may be appreciated by reference to the drawings, in which:

FIG. 1 schematically shows a typical client-server system in which the disclosed concepts, structures, and techniques may be advantageously embodied;

FIG. 2 is a flowchart for a method of storing a structured data record to an object store in accordance with an embodiment;

FIG. 3 is an illustration of a small tree of probabilistic filters being traversed during a search for a data record in a data object stored according to the flowchart of FIG. 2;

FIGS. 4A to 4D show plots of index access performance as a function of tree depth for various tunings of the probabilistic filters;

FIG. 5 is a flowchart for a method of retrieving a structured data record from an object store in accordance with an embodiment;

FIG. 6 shows a system for retrieving data from a remote storage device in accordance with another embodiment; and

FIG. 7 schematically shows relevant physical components of a computer that may be used, in whole or in part, to embody the concepts, structures, and techniques disclosed herein.

### DETAILED DESCRIPTION OF EMBODIMENTS

In this specification, including the appended claims, the following quoted term shall have the indicated meaning that is not limited to specific embodiments, except where expressly indicated otherwise.

An “approximate membership query” or “AMQ” filter is a space-efficient, probabilistic data structure used to test whether an element is a member of a set, a query of which will specify either that the element definitely is not in the set, or that the element may be in the set according to a false positive rate. Illustrative AMQ filters include the Bloom filter, the quotient filter, and the cuckoo filter.

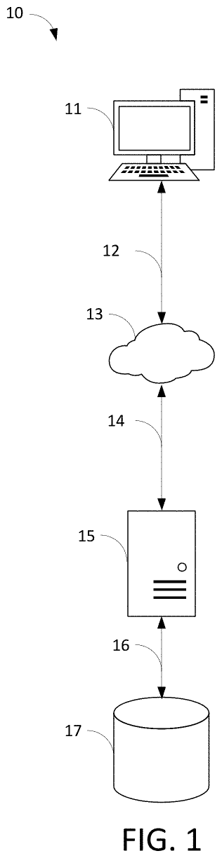

FIG. 1 schematically shows a typical client-server system in which the disclosed concepts, structures, and techniques may be advantageously embodied. In accordance with client-server principles, the system 10 includes at least one client device coupled for bidirectional data communication with at least one server device using a data network. Generally, the client requests, via the data network, that the server perform a computation or other function, and the server responsively fulfills the request, optionally returning a result or status indicator to the client via the data network.

Thus, the system 10 includes a client device 11. The client device 11 is illustrated as a desktop computer, but may be any electronic device known in the art, including without limitation a laptop computer, tablet computer, smartphone, embedded system, or any other device capable of transmitting and receiving data, and requesting that another electronic device perform a computation.

The client device 11 is coupled, via a data link 12, to a data network 13. The data link 12 is any combination of hardware or software suited for communicating data between the client device 11 and other electronic devices via the data network 13. The data link 12 may be, for example, a wired Ethernet link based on the Institute of Electrical and Electronics Engineers (“IEEE”) 802.3 family of standards, a wireless radio link based on the IEEE 802.11 family of standards (“Wi-Fi”), or any other data connection.

The data network 13 is any combination of hardware or software suited for communicating data between electronic devices via data links. The data network 13 may be, for example, a local area network (“LAN”), a wide area network (“WAN”), a metropolitan area network (“MAN”), a virtual private network (“VPN”), the Internet, or any other type of data network.

It is appreciated that a data network 13 operates to mediate data communication between multiple electronic devices. Thus, the depiction of only a single client device 11 in FIG. 1 is merely illustrative, and a typical system 10 may have any number of client devices coupled for data communication using corresponding data links to the data network 13. It is also appreciated that the data network 13 may be operated by any number of autonomous entities, and thus may be a conglomeration of smaller networks that exchange data according to standardized protocols and data formats, including without limitation the Internet Protocol (“IP”) specified by Internet Standard STD 5, the User Datagram Protocol (“UDP”) specified by Internet Standard STD 6, and the Transmission Control Protocol (“TCP”) specified by Internet Standard STD 7, among others.

The data network 13 allows the client device 11 to communicate with a server device 15, which is coupled to the data network 13 using a data link 14. The data link 14 is any combination of hardware or software suited for communicating data between the server device 15 and other electronic devices via the data network 13. The server device 15 may be any electronic device known in the art that is capable of transmitting and receiving data, and performing a computation on behalf of another electronic device.

Again, the data network 13 operates to mediate data communication between multiple electronic devices. Thus, the depiction of only a single server device 15 in FIG. 1 is merely illustrative, and a typical system 10 may have any number of server devices coupled for data communication using corresponding data links to the data network 13. In particular, to provide simultaneous service to large numbers of client devices, a particular computation (or type of computation, such as rendering a web page) may be allocated to one of multiple server devices using a load balancer or other device. It is further appreciated that the server device 15, along with additional server devices if required, may provide well-defined operations known as “services” according to a service-oriented architecture (“SOA”), as those terms are known in the art.

It is appreciated in accordance with client-server principles that the designation of device 11 as the “client device” and device 15 as the “server device” is arbitrary, as most electronic devices that are capable of transmitting and receiving data can perform computations on behalf of other electronic devices upon receipt of data, so requesting, according to a mutually agreed protocol. Thus, the designation of “client device” and “server device” is made herein with regard to an intended mode of operation of the system 10, namely that the client device 11 is the device requesting that a particular computation be performed on behalf of a user thereof, and that the server device 15 operates a “service” to perform the computation and communicate the results to the client device 11. A typical protocol for such interaction is the Hypertext Transfer Protocol (“HTTP” or “HTTP/1.1”) specified as a proposed Internet Standard by Requests for Comment (“RFC”) 7230 through 7235, which is used to implement the World Wide Web.

FIG. 1 shows the server device 15 coupled, via a storage link 16, to a data storage device 17. The data storage device 17 may be a database, file system, volatile or non-volatile memory, network attached storage (“NAS”), storage area network (“SAN”), or any other hardware or software that is capable of storing data used by a server device 15 or a service executing thereon. The storage link 16 may be any hardware or software capable of communicating data between the server device 15 and the data storage device 17. It is appreciated that, where more than one server device 15 is present, multiple server devices may communicate with the same data storage device 17 to provide data sharing between the server devices.

It is appreciated that a requested computation may be done in several parts, thereby requiring the system 10 to retain an intermediate computational state between requests. If the services provided by the server device 15 do not store any such state (for example, to simplify their design), then the client device 11 must supply all state with each request. This type of communication may be provided using the representational state transfer (“REST”) client-server architecture. In addition to being a stateless client-server architecture, REST systems permit responses to requests with identical inputs to be cached to improve response time; permit layering of services, thereby multiplying available functionality; permit services to require clients to perform some computation locally to improve performance; and provide a uniform interface for all client devices.

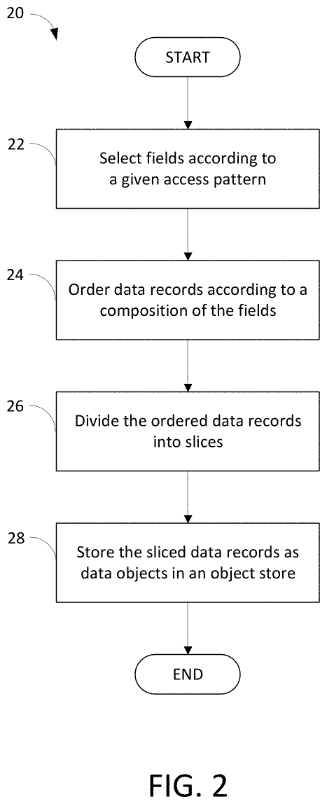

In FIG. 2 is shown a flowchart for a method 20 of storing a structured data record to an object store in accordance with an embodiment. Illustratively, the method 20 may be used by the server device 15 of FIG. 1 to obtain a data record in the course of fulfilling a request from a client device 11 as part of a web service. In this situation, it is anticipated that the server device 15 may access the data record from either the local data storage device 17, or from another (e.g. remote, cloud-based) storage device according to operational needs. It is appreciated that the method 20 may be used in other contexts and in other environments for other purposes.

In a first process 22, a collection of indexes or database fields is selected to cover all of the desired data records. As is known in the art of databases, if individual records are sequentially numbered or otherwise provided a unique identifier (a “primary key”), particular records may be searched by specifying the primary key in a query (more specifically, in the WHERE clause of a SQL query). As is also known, records of different types (e.g. an “employee” record and an “address” record) may be linked together by storing, in each record, the primary key of the linked record (as a “foreign key”). In many-to-many linking situations, where each of the first type of record may be associated with several of the second type and vice versa, several such keys may be required in combination to uniquely determine a particular record. It is also appreciated that some queries may be used to identify records whose field values lie within certain ranges (e.g. in a search for records containing dates or times). Thus, the first step in storing all of the structured data records is to determine a set of these keys (or more generally, fields) whose values provide full coverage of all data records according to a given record access pattern.

The method 20 continues with a second process 24, in which the data records are ordered according to these keys. A simple method for doing so is to assign, to each data record, a search string or search key that is a concatenation or other composition of the values of each of the database keys identified in the first step. The composed values are herein collectively called a “search key.” Search keys may be ordered using, for example, lexicographic (dictionary) order to thereby order the corresponding structured data records. It is appreciated that techniques other than concatenation (e.g. hashing) may be used to create the search keys, and thus to order the data records. However, concatenation of field values is a technique that lends itself to consecutive ordering of data records that are already logically grouped (e.g. all records created on a certain day, or with respect to a certain location or other relevant field), which may be advantageous in some embodiments.

The method 20 next enters a third process 26, in which the ordered data records are divided into blocks or “slices” of consecutive records. This process may be performed using conventional means. Thus, a fixed, pre-determined size of each object for storage in the object store may be divided by the size of each data record to yield a number of records per object, and this number of consecutive records may constitute a single slice of the dataset. It is appreciated that a set of ordered, structured data records may be divided into blocks or slices using other methods without deviating from the concepts, techniques, and structures disclosed herein.

The method 20 then moves to a fourth process 28, in which each of the slices is stored as an opaque data object in an object store. Each object store operates according to a data storage protocol, and the process 28 uses this protocol to store the data object. In exchange, the object store provides a pointer, handle, or name that may be used to later retrieve the stored data object. The process 28 may be performed using techniques known in the art, and data storage systems known in the art make these returned handles or names searchable via an object index. That is, known data storage systems may associate a semantic filename with a data storage handle. As described below, however, disclosed embodiments instead make these pointers searchable on the basis of which data records are stored within the corresponding data objects; that is, searchable via a record index, so that many different record indices may be associated with a single pointer (i.e. associated with a single data object).

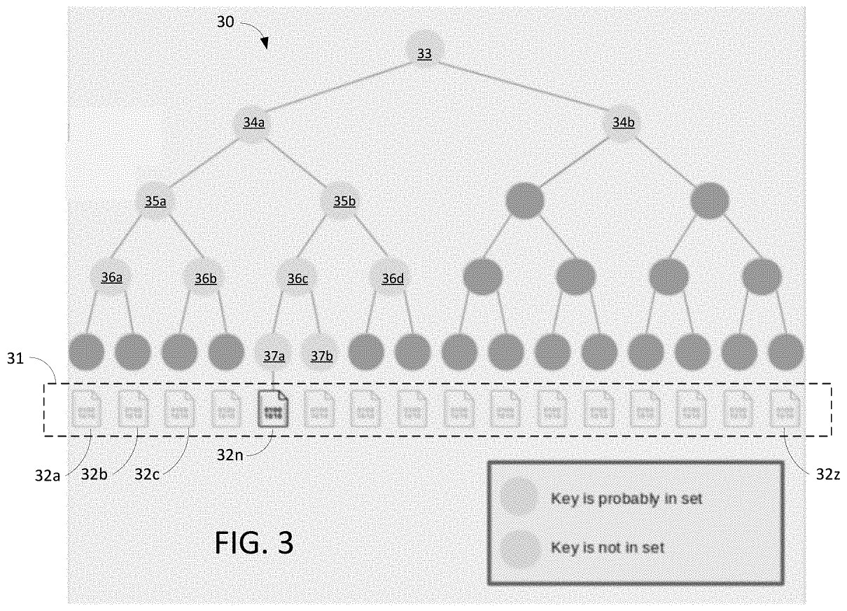

The problem of determining the correct data object for a given data record is solved using search trees having probabilistic filters at each node. Thus, in FIG. 3 is shown an illustration of a small binary search tree (BST) 30 having nodes with probabilistic filters being traversed during a search for a data record in accordance with an embodiment. The object store 31 may store many, many data objects 32a-32z (collectively, “data objects 32”). Typically, the object store 31 is a local or remote file system, implemented using any number of physical storage devices (e.g. disk or solid state drives). The data objects 32 have many names (e.g. Amazon S3 calls them “buckets”), but in typical use represent unstructured data such as images, videos, documents, or files. Each of the data objects 32 is accessible using an address or handle (e.g. “bucket name”), referred to more generally herein as a “pointer”.

In accordance with disclosed embodiments that may have petabytes or more of structured data (e.g. database records), the data objects 32 are containers for that structured data. However, because these containers are stored using a data object store, which is agnostic with respect to structure in the underlying data records, disclosed embodiments provide a binary search tree 30 for indexing the records. Thus, the data object (say, data object 32n) in the data store 31 that contains a given data record may be efficiently retrieved by searching the tree on the basis of the data record, not the data object.

The BST 30 is constructed so that the search keys of all data records “under” each node are added to a probabilistic filter for the node. Probabilistic filters, and especially Bloom filters, are known in the art. Bloom filters operate to indicate whether a given datum is probably an element, or is definitely not an element, of a particular set as follows. The Bloom filter consists of a set of k hash functions, each mapping its input to one of m different bits with a uniform random distribution. To add an element to the filter, apply each hash function to the element to produce a set of at most k of the m bits; set the values of each of these bits to “1”. To determine whether a given element was added to the filter, apply the k hash functions to the element to produce its pattern of “1” bits. If any of those bits are not found in the Bloom filter, then the given element definitely was not added to the filter. In other words, the filter does not produce any “false negatives.” However, if all of those bits are found in the filter, then the given element probably is in the filter, but may not be due to the relatively unlikely event of a hash collision. This probability of a “false positive” due to a hash collision can be tuned to any desired value by varying the parameters k and m, and is typically set at around 3%. Other probabilistic filters, e.g. other approximate membership query (AMQ) filters, operate by similar means that are known in the art and thus not described here.

Returning to FIG. 3, suppose it is desired to locate a structured data record that happens to be stored in data object 32n. A depth-first search of the binary search tree (BST) 30 will locate the data record as follows. First, create a search key for the data record as described above in connection with FIG. 2. Next, apply an AMQ filter (such as a Bloom filter) found at the root node 33 of the BST 30. Since the search key is stored in the object store 31, the root node 33 will have a filter that indicates the search key “is probably” stored in a subtree containing the root node 33. Since this root node 33 covers the entire object store 31, the result indicates that the search key is probably stored in the object store 31.

Given an indication to proceed by the root node 33, the search continues to traverse the subtrees anchored by the two child nodes 34a and 34b. Each of these nodes 34a and 34b covers a different subset of data records stored in the object store 31 and has an AMQ filter with different hash functions than the root node. In this way, the patterns in each filter are statistically independent of those in the other filters, so the probability of obtaining a false positive multiplies with each level traversed. If the BST 30 has enough levels with different filters in each level, the probability of obtaining a false positive match advantageously becomes infinitesimal.

As may be appreciated from FIG. 3, the filter of node 34b returned a definitive “not present” result for the given search key, and the search for its associated data record may stop with respect to that node and its children. But the desired data record is actually stored in the object store 31, so a query of the filter of node 34a must (and does) return a “probably present” result, and the search process continues to traverse the subtrees of the children of node 34a.

The query of the filters of the nodes 35a and 35b produces a curious result: the search key is “probably present” under both. This situation indicates a false positive, i.e. applying the hash functions of both child nodes 35a and 35b results in bit patterns that happen to be present in their respective filters, but one of these is incorrect. Indeed, the children of node 35a, namely nodes 36a and 36b, both have filters that definitively exclude the given search key. Thus, the false positive was in the filter of node 35a; that is, there was a collision in that filter between the hash values for the given search key and hash values of some combination of other keys that were actually added to that filter.

Continuing the depth-first search in the children of node 35b, namely nodes 36c and 36d, the latter has a filter that definitively excludes the given search key, while the former has a filter that indicates the search key is “probably present.” Likewise, node 36c has child nodes 37a and 37b, and only node 37a has a filter that registers a “probably present” result. However, as the node 37a is actually a leaf node (i.e. it has no children), the search process concludes by requesting, from the object store 31, the data object associated with that leaf node 37a, which is the only data object that could include the sought data record. In this case, that is the data object 32n which illustratively does contain the structured data record having the given search key. Retrieval of the data object 32n itself may be accomplished using standard means, such as querying the object store 31 using a handle for the data object 32n that is stored in the leaf node 37a.

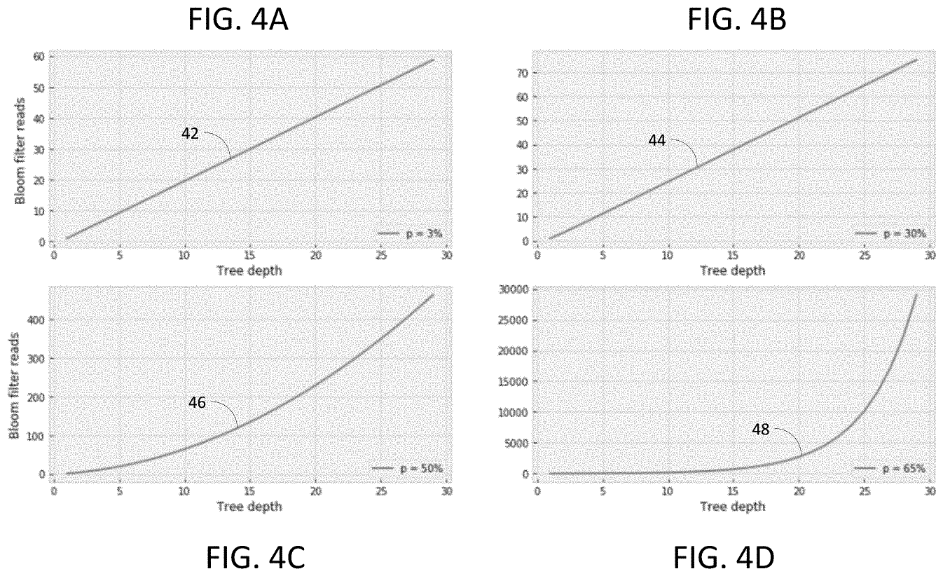

FIGS. 4A to 4D show plots of index access performance as a function of tree depth for various tunings of the probabilistic filters in BSTs as shown in FIG. 3 and discussed above. In particular, these figures simulate the number of Bloom filter reads or queries as a function of tree depth to reach a leaf node when the false positive probability p is 3% (FIG. 4A), 30% (FIG. 4B), 50% (FIG. 4C), and 65% (FIG. 4D). In the unattainable ideal case where hash collisions do not occur and the filter produces no false positives, the total number of Bloom filter queries will be exactly twice the tree depth. This is because at each level, two child nodes will be queried, and exactly one of the children will register a definitive “absent” while the other will register a “probably present” with 100% probability.

With respect to FIG. 4A, a false positive probability of 3% means there is a 3% chance that one of the two child nodes at each level will record a “probably present” when the tested search key in fact is absent. As this probability is quite low, the curve 42 shown in FIG. 4A stays very close to the ideal 2:1 ratio, with about 51 reads required with a tree depth of 25 (corresponding to 2²⁵=33,554,432 stored data objects). With respect to FIG. 4B, even a much higher false positive probability of 30% results in a curve 44 that is still approximately linear, but less efficient as about 65 reads are required with a tree depth of 25. Thus, it is appreciated that embodiments may perform sufficiently well with false positive probabilities as high at 30%.

Contrast these situations to FIG. 4C, in which a false positive probability of p=50% means that a search of the BST results in a false positive as likely as not, i.e. a false positive on average every other level. With such an imprecise filter, the number of filter queries required (i.e. the curve 46) rises rapidly, and about 350 filter reads are required for a tree having depth of 25. Likewise, in FIG. 4D with p=65%, the number of filter reads clearly shows its exponential growth in curve 48, and a depth-first search of a BST having depth 25 requires 10,000 filter queries, completely obviating the usefulness of the technique. It is therefore important that the filters are tuned to a low rate of false positives, but as shown in FIGS. 4A to 4D, the design is relatively forgiving in this regard.

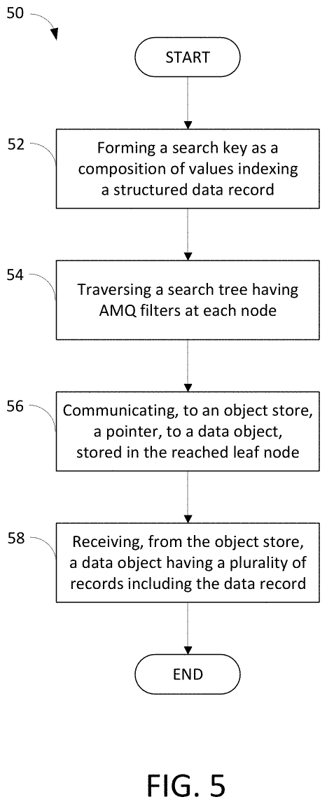

FIG. 5 is a flowchart for a method 50 of retrieving a structured data record from an object store in accordance with an embodiment. The method 50 includes a process 52 forming a search key as a composition of one or more values that index the structured data record. As described above, the indexing values may be database keys. Alternately, the indexing values may include a sequence number of the data record within the plurality of data records in the data object to be received. It is appreciated that other compositions of indexing values may be formed in various embodiments. Importantly, however, the search key is uniquely associated with the structured data record.

The method 50 continues with a process 54 traversing a search tree that covers the space of possible search keys. In illustrative embodiments, the search tree is a binary search tree (BST). This process 54 was described above in connection with FIG. 3, and operates substantially as described there. In detail, the process 54 starts from a root node (e.g. node 33) and continues until a leaf node (e.g. node 37a) is reached. For each encountered node, the process 54 uses an approximate membership query (AMQ) filter (such as a Bloom filter, a quotient filter, or a cuckoo filter) for that node to determine whether a subtree containing the node cannot include the search key. That is, the probabilistic filter determines only whether (a) the search key definitely cannot be found in the node or a descendant node, or (b) the search key might be found in the node or a descendant node, with a certain false positive probability. Thus, if it is not the case that the search key is definitely ruled out from the subtree containing the encountered node, the process 54 recursively traverses that subtree. In illustrative embodiments, the characteristic false positive probability is between 1% and 30%, and preferably approximately 3%.

The method 50 next includes a process 56 communicating, to a data object store, a pointer, handle, or object name associated with the leaf node that was reached. In some embodiments, a data structure representing the leaf node that was reached may store this pointer. Communicating itself may be performed using techniques known in the art. For example, if the data object store is a cloud storage service or cloud storage device, communicating may include using an appropriate RESTful interface.

The method 50 concludes with a process 58 responsively receiving, from the data object store, a data object having a plurality of data records, of which the structured data record is one. That is, the method 50 seeks a particular structured data record, recognizes that it is stored in a data object that is externally opaque, and searches for and retrieves the correct data object according to properties of the data record (as embodied in the search key).

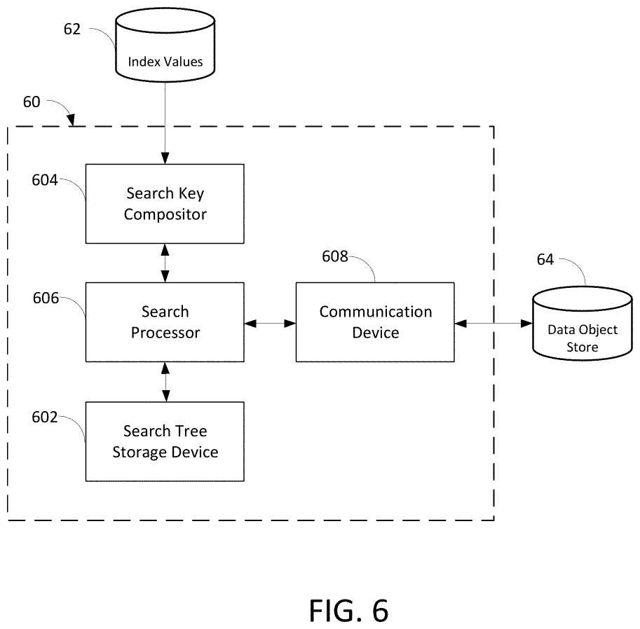

FIG. 6 shows a system 60 for obtaining a structured data record in accordance with another embodiment. The system 60 converts index values 62 that uniquely represent a structured data record into a search key, search a tree for an associated data object, then retrieve that data object from a data object store 64. Thus, the system 60 may be used to implement the method 50 of FIG. 5. In some embodiments, the system 60 also may be used to implement the method 20 of FIG. 2.

The system 60 includes a storage device 602 storing a search tree that covers the space of possible search keys, the search tree having nodes that each provide an approximate membership query (AMQ) filter for a subset of the possible search keys. The storage device 602 may be, for example, a conventional volatile memory, although it is appreciated that in some embodiments part or all of the search tree may be saved to persistent storage, such as a hard drive or solid state drive. As discussed above, the search tree may be a binary search tree (BST). As also discussed above, the AMQ filter may be or include a Bloom filter, or a quotient filter, or a cuckoo filter, according to a characteristic false positive probability between 1% and 30%.

The system 60 also has a search key compositor 604 for forming a search key as a composition of one or more values that index the structured data record, whereby the search key is uniquely associated with the structured data record. The index values may be database keys, or include a sequence number of the data record within the plurality of data records in the data object to be received, or other such metadata that uniquely identify the structured data record. The search key compositor 604 obtains index values 62 for the structured data record to be searched, then composes them to form the search key. Composition of values may include, for example, concatenation so that structured data records having similar properties (as represented by like values) are stored in the same data object.

The system 60 further has a search processor 606 for searching the search tree stored in the storage device 602. The search processor 606 may illustratively include a computing processor as known in the art. The search processor 606 starts the search from a root node and continues until a leaf node is reached. At each encountered node, the search processor 606 uses the filter for that node to determine whether a subtree containing that node cannot include the search key, and if that is not the case, the search processor 606 performs a traversal of that subtree, which advantageously may be a depth-first traversal.

The system 60 also includes a communication device 608 for communicating, to a data object store 64, a pointer associated with the leaf node that was reached, and for responsively receiving, from the data object store 64, a data object having a plurality of data records, of which the sought structured data record is one. The communication device 608 illustratively includes a network interface card (NIC) when the data object store 64 comprises a cloud storage service or device.

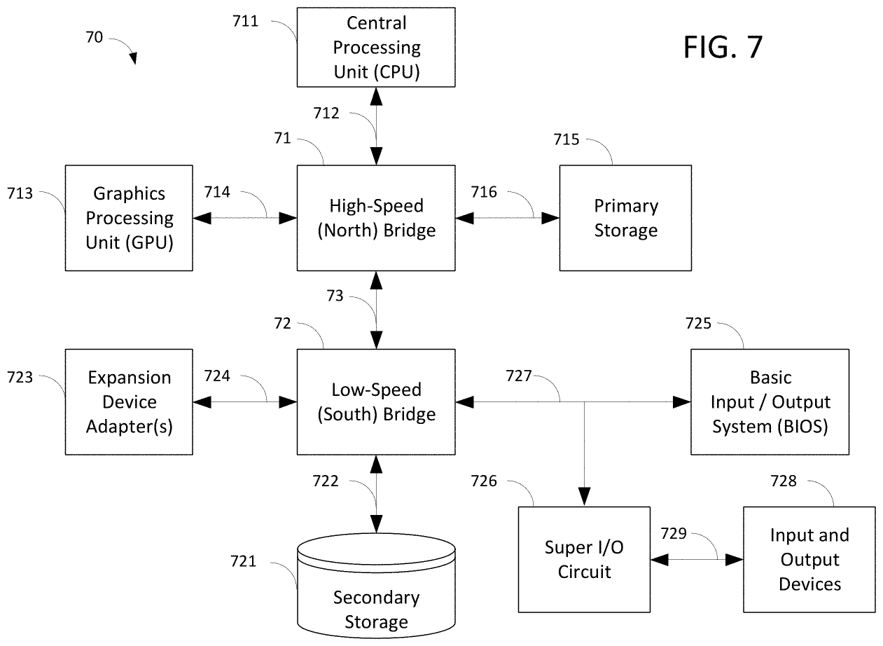

FIG. 7 schematically shows relevant physical components of a computer 70 that may be used to embody the concepts, structures, and techniques disclosed herein. In particular, the computer 70 may be used to implement, in whole or in part, the system 10 or any of its components, the method 20 or any of its processes, the method 50 or any of its processes, or the system 60 or any of its components. The computer 70 has many functional components that communicate data with each other using data buses. The functional components of FIG. 7 are physically arranged based on the speed at which each must operate, and the technology used to communicate data using buses at the necessary speeds to permit such operation.

Thus, the computer 70 is arranged as high-speed components and buses 711 to 716 and low-speed components and buses 721 to 729. The high-speed components and buses 711 to 716 are coupled for data communication using a high-speed bridge 71, also called a “northbridge,” while the low-speed components and buses 721 to 729 are coupled using a low-speed bridge 72, also called a “southbridge.”

The computer 70 includes a central processing unit (“CPU”) 711 coupled to the high-speed bridge 71 via a bus 712. The CPU 711 is electronic circuitry that carries out the instructions of a computer program. As is known in the art, the CPU 711 may be implemented as a microprocessor; that is, as an integrated circuit (“IC”; also called a “chip” or “microchip”). In some embodiments, the CPU 711 may be implemented as a microcontroller for embedded applications, or according to other embodiments known in the art.

The bus 712 may be implemented using any technology known in the art for interconnection of CPUs (or more particularly, of microprocessors). For example, the bus 712 may be implemented using the HyperTransport architecture developed initially by AMD, the Intel QuickPath Interconnect (“QPI”), or a similar technology. In some embodiments, the functions of the high-speed bridge 71 may be implemented in whole or in part by the CPU 711, obviating the need for the bus 712.

The computer 70 includes one or more graphics processing units (GPUs) 713 coupled to the high-speed bridge 71 via a graphics bus 714. Each GPU 713 is designed to process commands from the CPU 711 into image data for display on a display screen (not shown). In some embodiments, the CPU 711 performs graphics processing directly, obviating the need for a separate GPU 713 and graphics bus 714. In other embodiments, a GPU 713 is physically embodied as an integrated circuit separate from the CPU 711 and may be physically detachable from the computer 70 if embodied on an expansion card, such as a video card. The GPU 713 may store image data (or other data, if the GPU 713 is used as an auxiliary computing processor) in a graphics buffer.

The graphics bus 714 may be implemented using any technology known in the art for data communication between a CPU and a GPU. For example, the graphics bus 714 may be implemented using the Peripheral Component Interconnect Express (“PCI Express” or “PCIe”) standard, or a similar technology.

The computer 70 includes a primary storage 715 coupled to the high-speed bridge 71 via a memory bus 716. The primary storage 715, which may be called “main memory” or simply “memory” herein, includes computer program instructions, data, or both, for use by the CPU 711. The primary storage 715 may include random-access memory (“RAM”). RAM is “volatile” if its data are lost when power is removed, and “non-volatile” if its data are retained without applied power. Typically, volatile RAM is used when the computer 70 is “awake” and executing a program, and when the computer 70 is temporarily “asleep”, while non-volatile RAM (“NVRAM”) is used when the computer 70 is “hibernating”; however, embodiments may vary. Volatile RAM may be, for example, dynamic (“DRAM”), synchronous (“SDRAM”), and double-data rate (“DDR SDRAM”). Non-volatile RAM may be, for example, solid-state flash memory. RAM may be physically provided as one or more dual in-line memory modules (“DIMMs”), or other, similar technology known in the art.

The memory bus 716 may be implemented using any technology known in the art for data communication between a CPU and a primary storage. The memory bus 716 may comprise an address bus for electrically indicating a storage address, and a data bus for transmitting program instructions and data to, and receiving them from, the primary storage 715. For example, if data are stored and retrieved 64 bits (eight bytes) at a time, then the data bus has a width of 64 bits. Continuing this example, if the address bus has a width of 32 bits, then 2³² memory addresses are accessible, so the computer 70 may use up to 8*2³²=32 gigabytes (GB) of primary storage 715. In this example, the memory bus 716 will have a total width of 64+32=96 bits. The computer 70 also may include a memory controller circuit (not shown) that converts electrical signals received from the memory bus 716 to electrical signals expected by physical pins in the primary storage 715, and vice versa.

Computer memory may be hierarchically organized based on a tradeoff between memory response time and memory size, so depictions and references herein to types of memory as being in certain physical locations are for illustration only. Thus, some embodiments (e.g. embedded systems) provide the CPU 711, the graphics processing units 713, the primary storage 715, and the high-speed bridge 71, or any combination thereof, as a single integrated circuit. In such embodiments, buses 712, 714, 716 may form part of the same integrated circuit and need not be physically separate. Other designs for the computer 70 may embody the functions of the CPU 711, graphics processing units 713, and the primary storage 715 in different configurations, obviating the need for one or more of the buses 712, 714, 716.

The depiction of the high-speed bridge 71 coupled to the CPU 711, GPU 713, and primary storage 715 is merely exemplary, as other components may be coupled for communication with the high-speed bridge 71. For example, a network interface controller (“NIC” or “network adapter”) may be coupled to the high-speed bridge 71, for transmitting and receiving data using a data channel. The NIC may store data to be transmitted to, and received from, the data channel in a network data buffer.

The high-speed bridge 71 is coupled for data communication with the low-speed bridge 72 using an internal data bus 73. Control circuitry (not shown) may be required for transmitting and receiving data at different speeds. The internal data bus 73 may be implemented using the Intel Direct Media Interface (“DMI”) or a similar technology.

The computer 70 includes a secondary storage 721 coupled to the low-speed bridge 72 via a storage bus 722. The secondary storage 721, which may be called “auxiliary memory”, “auxiliary storage”, or “external memory” herein, stores program instructions and data for access at relatively low speeds and over relatively long durations. Since such durations may include removal of power from the computer 70, the secondary storage 721 may include non-volatile memory (which may or may not be randomly accessible).

Non-volatile memory may comprise solid-state memory having no moving parts, for example a flash drive or solid-state drive. Alternately, non-volatile memory may comprise a moving disc or tape for storing data and an apparatus for reading (and possibly writing) the data. Data may be stored (and possibly rewritten) optically, for example on a compact disc (“CD”), digital video disc (“DVD”), or Blu-ray disc (“BD”), or magnetically, for example on a disc in a hard disk drive (“HDD”) or a floppy disk, or on a digital audio tape (“DAT”). Non-volatile memory may be, for example, read-only (“ROM”), write-once read-many (“WORM”), programmable (“PROM”), erasable (“EPROM”), or electrically erasable (“EEPROM”).

The storage bus 722 may be implemented using any technology known in the art for data communication between a CPU and a secondary storage and may include a host adaptor (not shown) for adapting electrical signals from the low-speed bridge 72 to a format expected by physical pins on the secondary storage 721, and vice versa. For example, the storage bus 722 may use a Universal Serial Bus (“USB”) standard; a Serial AT Attachment (“SATA”) standard; a Parallel AT Attachment (“PATA”) standard such as Integrated Drive Electronics (“IDE”), Enhanced IDE (“EIDE”), ATA Packet Interface (“ATAPI”), or Ultra ATA; a Small Computer System Interface (“SCSI”) standard; or a similar technology.

The computer 70 also includes one or more expansion device adapters 723 coupled to the low-speed bridge 72 via a respective one or more expansion buses 724. Each expansion device adapter 723 permits the computer 70 to communicate with expansion devices (not shown) that provide additional functionality. Such additional functionality may be provided on a separate, removable expansion card, for example an additional graphics card, network card, host adaptor, or specialized processing card.

Each expansion bus 724 may be implemented using any technology known in the art for data communication between a CPU and an expansion device adapter. For example, the expansion bus 724 may transmit and receive electrical signals using a Peripheral Component Interconnect (“PCI”) standard, a data networking standard such as an Ethernet standard, or a similar technology.

The computer 70 includes a basic input/output system (“BIOS”) 725 and a Super I/O circuit 726 coupled to the low-speed bridge 72 via a bus 727. The BIOS 725 is a non-volatile memory used to initialize the hardware of the computer 70 during the power-on process. The Super I/O circuit 726 is an integrated circuit that combines input and output (“I/O”) interfaces for low-speed input and output devices 728, such as a serial mouse and a keyboard. In some embodiments, BIOS functionality is incorporated in the Super I/O circuit 726 directly, obviating the need for a separate BIOS 725.

The bus 727 may be implemented using any technology known in the art for data communication between a CPU, a BIOS (if present), and a Super I/O circuit. For example, the bus 727 may be implemented using a Low Pin Count (“LPC”) bus, an Industry Standard Architecture (“ISA”) bus, or similar technology. The Super I/O circuit 726 is coupled to the I/O devices 728 via one or more buses 729. The buses 729 may be serial buses, parallel buses, other buses known in the art, or a combination of these, depending on the type of I/O devices 728 coupled to the computer 70.

The techniques and structures described herein may be implemented in any of a variety of different forms. For example, features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Having described implementations which serve to illustrate various concepts, structures, and techniques which are the subject of this disclosure, it will now become apparent to those of ordinary skill in the art that other implementations incorporating these concepts, structures, and techniques may be used. Accordingly, it is submitted that that scope of the patent should not be limited to the described implementations but rather should be limited only by the spirit and scope of the following claims.

What is claimed is:

1. A system for obtaining a structured data record, the system comprising:
a storage device for storing a search tree that covers the space of possible search keys, the search tree having nodes that each provide an approximate membership query filter for a subset of the possible search keys;
a search key compositor for forming a search key as a composition of one or more values that index the structured data record, whereby the search key is uniquely associated with the structured data record;
a search processor for searching the search tree, starting from a root node and continuing until a leaf node is reached, by: for each encountered node, using the filter for that node to determine whether a subtree containing that node cannot include the search key, and if that is not the case, then traversing that subtree; and
a communication device for communicating, to a data object store, a pointer associated with the leaf node that was reached, and for responsively receiving, from the data object store, a data object having a plurality of data records, of which the structured data record is one.

2. The system according to claim 1, wherein the storage device stores a binary search tree.

3. The system according to claim 1, wherein each node in the search tree stored in the storage device provides an approximate membership query filter comprising a Bloom filter, or a quotient filter, or a cuckoo filter, according to a characteristic false positive probability between 1% and 30%.

4. The system according to claim 1, wherein the search key compositor is configured to form the search key as a composition of one or more database keys that index the structured data record.

5. The system according to claim 1, wherein the search key compositor is configured to form the search key to include a sequence number of the data record within the plurality of data records in the data object to be received.

6. The system according to claim 1, wherein the communication device is configured for communicating with a data object store that comprises a cloud storage service or a cloud storage device.

7. A method of obtaining a structured data record, the method comprising:
forming a search key as a composition of one or more values that index the structured data record, whereby the search key is uniquely associated with the structured data record;
traversing a search tree that covers the space of possible search keys, starting from a root node and continuing until a leaf node is reached, by: for each encountered node, using an approximate membership query filter for that node to determine whether a subtree containing that node cannot include the search key, and if that is not the case, then traversing that subtree;
communicating, to a data object store, a pointer associated with the leaf node that was reached; and
responsively receiving, from the data object store, a data object having a plurality of data records, of which the structured data record is one.

8. The method according to claim 7, wherein the search tree includes a binary search tree.

9. The method according to claim 7, wherein using the approximate membership query filter for each encountered node comprises using a Bloom filter, or a quotient filter, or a cuckoo filter, according to a characteristic false positive probability.

10. The method according to claim 9, wherein the characteristic false positive probability is between 1% and 30%.

11. The method according to claim 7, wherein forming the search key comprises forming the search key as a composition of one or more database keys that index the structured data record.

12. The method according to claim 7, wherein forming the search key comprises forming the search key including a sequence number of the data record within the plurality of data records in the data object to be received.

13. The method according to claim 7, wherein the data object store is a cloud storage service or cloud storage device.

14. A tangible, computer-readable storage medium, in which is non-transitorily stored computer program code for performing a method of obtaining a structured data record, the method comprising:
forming a search key as a composition of one or more values that index the structured data record, whereby the search key is uniquely associated with the structured data record;
traversing a search tree that covers the space of possible search keys, starting from a root node and continuing until a leaf node is reached, by: for each encountered node, using an approximate membership query filter for that node to determine whether a subtree containing that node cannot include the search key, and if that is not the case, then traversing that subtree;
communicating, to a data object store, a pointer associated with the leaf node that was reached; and
responsively receiving, from the data object store, a data object having a plurality of data records, of which the structured data record is one.

15. The storage medium according to claim 14, wherein the search tree includes a binary search tree.

16. The storage medium according to claim 14, wherein using the approximate membership query filter for each encountered node comprises using a Bloom filter, or a quotient filter, or a cuckoo filter, according to a characteristic false positive probability.

17. The storage medium according to claim 16, wherein the characteristic false positive probability is between 1% and 30%.

18. The storage medium according to claim 14, wherein forming the search key comprises forming the search key as a composition of one or more database keys that index the structured data record.

19. The storage medium according to claim 14, wherein forming the search key comprises forming the search key including a sequence number of the data record within the plurality of data records in the data object to be received.

20. The storage medium according to claim 14, wherein the data object store is a cloud storage service or cloud storage device.
